(19) United States
(12) Patent Application Publication
(10) Pub. No.: US 2026/0328179 A1
(43) Pub. Date: Oct. 22, 2026

(54) ROTOR BLADE FOR A WIND TURBINE AND ROTOR BLADE TIP

(71) Applicant: Nordex Energy SE & Co. KG, Hamburg (DE)

(72) Inventor: Mehdi Doosttalab, Norderstedt (DE)

(21) Appl. No.: 19/105,713

(22) PCT Filed: Aug. 23, 2023
(86) PCT No.: PCT/EP2023/073110

§ 371 Date: Feb. 21, 2025

(30) Foreign Application Priority Data
Aug. 25, 2022 (DE) 10 2022 121 502.4

(51) Int. Cl. F03D 1/06; F03D 80/00

(52) U.S. Cl. CPC F03D 1/0645; F03D 1/0648; F03D 1/06495; F03D 1/0687; F03D 80/005; F05B 2240/304; F05B 2240/311; F05B 2260/96

(57) ABSTRACT

A rotor blade is for a wind turbine and has a rotor blade main body and a rotor blade tip adjoining the rotor blade main body, a suction-side surface, a pressure-side surface and a profile trailing edge, wherein—downstream edges of the suction-side surface and of the pressure-side surface are joined together at the profile trailing edge, and—the rotor blade tip has a flexibly configured trailing edge element which, in terms of its shaping, is aligned flush with the outer contour of the suction-side surface and of the pressure-side surface of the rotor blade and forms a portion of the profile trailing edge of the rotor blade such that the profile trailing edge of the rotor blade extends monotonically in the direction of a tip-side end of the rotor blade at the rotor blade tip.

### CROSS-REFERENCE TO RELATED APPLICATIONS

This application is a continuation application of international patent application PCT/EP2023/073110, filed Aug. 23, 2023, designating the United States and claiming priority from German application 10 2022 121 502.4, filed Aug. 25, 2022, and the entire content of both applications is incorporated herein by reference.

### TECHNICAL FIELD

The disclosure relates to a rotor blade for a wind turbine which has a rotor blade main body, a rotor blade tip which adjoins the rotor blade main body, a suction-side surface and a pressure-side surface. The disclosure further relates to a rotor blade tip for a rotor blade.

### BACKGROUND

Wind turbines are used to convert energy of the wind into electrical energy. To this end, they conventionally have one or more rotor blades (also referred to as wind turbine rotor blades).

Rotor blades may be provided with aerodynamically effective attachment elements in order to selectively influence the air flowing around the wind turbine rotor blade during operation. For example, there are known attachment elements which are arranged along the profile trailing edge and which improve the aerodynamic properties of the blade via spikes. In this regard, reference may be made by way of example to the publications US 2011/0142635 or WO 2017/148669 A1.

In accordance with the current trend, in modern wind turbines increasingly long rotor blades which, for example, may each have a weight of up to 35 tons and a length of up to 90 meters are used. Particularly with such long rotor blades, there is typically a particularly high swing of the angle of attack which is produced by the rotor blade rotation and the linked change of the so-called angle of attack at the rotor blade tip. This is in particular a result of the fact that such long rotor blades are generally significantly more flexible compared with smaller, in particular shorter rotor blades (for example, 60 m long). This phenomenon leads to a breakaway of the air during operation which results in the production of undesirable sounds or noise.

### SUMMARY

An object on which the disclosure is based is to provide a rotor blade and a rotor blade tip which contributes to a particularly effective reduction of noises or even complete prevention thereof.

This object is achieved by various embodiments of the disclosure.

According to an aspect, a rotor blade for a wind turbine is disclosed. The rotor blade has a rotor blade main body, a rotor blade tip which adjoins the rotor blade main body, a suction-side surface, a pressure-side surface and a profile trailing edge. Downstream edges of the suction-side surface and the pressure-side surface are connected to each other at the profile trailing edge. The rotor blade tip has a flexible trailing edge element which is adapted with regard to its shaping flush with the outer contour of the suction-side surface and the pressure-side surface of the rotor blade and which forms a portion of the profile trailing edge of the rotor blade so that the profile trailing edge of the rotor blade at the rotor blade tip, at least the portion of the profile trailing edge, extends in the direction of a tip-side end of the rotor blade in a monotonous manner.

According to various embodiments, a trailing edge element is provided on the rotor blade tip. The trailing edge element is fitted flush in the outer contour of the rotor blade and which is configured in such a flexible manner that it can become deformed under the influence of the air flow during correct operation of the rotor blade. For example, it may give way or bend in accordance with the air flow in the direction of the suction side or in the direction of the pressure side. In other words, the trailing edge element enables a change of the profile cross section in the region of the profile trailing edge or a profile trailing edge portion, wherein it changes its orientation (in the profile thickness direction) at least partially depending on the flow. By using such a flexible profile trailing edge, a particularly effective pressure compensation between the pressure side and the suction side is enabled. Furthermore, this contributes to a flow separation not being formed or being formed less easily at the pressure and/or suction side. Furthermore, as a result of the improved pressure compensation a contribution is made to the size of so-called rotor blade tip vortexes which represent another source of noise for a wind turbine being reduced. The disclosure consequently enables the aeroacoustic noise at the rotor blade tip to be reduced or avoided, in particular with particularly long rotor blades.

The rotor blade tip may be understood to be a portion of the rotor blade. For example, the rotor blade tip and rotor blade main body define two (longitudinal) portions of the rotor blade. The rotor blade tip may be constructed in an identical manner to the rotor blade main body. For example, the rotor blade tip is configured integrally with the rotor blade main body.

Alternatively the rotor blade tip is a component which is separate from the rotor blade main body. The rotor blade tip has in this instance a structure which is different from the main body and/or it may be produced from a different material. For example, the rotor blade tip is produced from a metal material. For example, the rotor blade tip is in the form of a lightning receptor, wherein the rotor blade tip is produced for this case, for example, from the aluminum material.

Alternatively, the rotor blade tip is in the form of a rotor blade segment of a rotor blade which is divided (transversely with respect to the longitudinal axis). In this instance, the rotor blade tip and rotor blade main body are, for example, constructed in an identical or similar manner. They may also be constructed differently.

The rotor blade tip in whichever of the embodiments set out above has, for example, a length of up to 10%, in a particularly preferred manner of from 0 to 3%, of the overall length of the rotor blade with respect to a longitudinal axis of the rotor blade (that is, from the rotor blade root to the tip-side end of the rotor blade). The rotor blade tip always has in this context an axial extent along the longitudinal axis of the rotor blade and defines, for example, no point or an end point of the rotor blade.

The rotor blade tip is an integral component of the rotor blade and has the trailing edge element according to the disclosure. The trailing edge element is an element which is separate from the rotor blade tip. For the trailing edge element, the rotor blade tip has, for example, a recessed region (starting from the profile trailing edge) or a recess so that the trailing edge element is inserted flush into the outer contour of the rotor blade. In other words, the trailing edge element terminates at least at the suction and pressure side flush with the remaining rotor blade or remaining rotor blade tip. Preferably, the trailing edge element terminates at all the outer sides flush with the rotor blade so that everywhere on the outer contour a seamless transition is provided.

The flexible configuration means that the trailing edge element has in comparison with the remaining rotor blade or rotor blade tip a greater resilient deformability.

The monotonous path of the profile trailing edge which is defined by the trailing edge element at the rotor blade tip means that the path remains consistent or changes in the same direction, for example, with respect to the longitudinal axis of the rotor blade. For example, the path is curved, wherein no direction change of the curvature takes place. In other words, the trailing edge element does not form a profile trailing edge portion with an undulating, spiked or otherwise alternating path.

The profile trailing edge is the edge, which is located furthest leeward in the flow direction, of the rotor blade. The edges of the suction-side surface or pressure-side surface are consequently those edges which during correct operation of the rotor blade are located furthest downstream with respect to the air flow.

According to various embodiments, between the trailing edge element and the remaining rotor blade along the profile trailing edge a substantially seamless, in particular stepless, transition is formed. The trailing edge element thereby seamlessly takes up the path of the profile trailing edge of the remaining rotor blade in the region of the rotor blade tip. In other words, the trailing edge element seamlessly continues the path of the profile trailing edge. This contributes in a particularly advantageous manner to the aeroacoustic properties of the rotor blade at the rotor blade tip.

According to various embodiments, the trailing edge element is free from a profile depth expansion at the profile trailing edge. A so-called chord extension of the rotor blade at the rotor blade tip is consequently not included. This contributes to the mentioned aeroacoustic properties of the rotor blade at the rotor blade tip.

According to various embodiments, the portion, which is formed by the trailing edge element, of the profile trailing edge of the rotor blade has a curvature which changes in a monotonous manner. This enables the above-mentioned advantages and functions.

According to various embodiments, the trailing edge element is formed from an elastomer material. Consequently, a flexible, resilient plastics material is provided. For example, this is a rubber, PU (polyurethane), PU mixture/hybrid which remains flexible in the event of temperature fluctuation.

According to various embodiments, the rotor blade tip is configured separately from the rotor blade main body and is connected to the rotor blade main body. This enables a separate production of the rotor blade tip. For example, a separate fitting or assembly of the trailing edge element is possible. A contribution is also made to the trailing edge element, for instance in the event of wear, being able to be replaced particularly easily.

According to various embodiments, the rotor blade tip is formed from an electrically conductive material, in particular a metal material. This contributes in a particularly advantageous manner to an assembly of the trailing edge element since particularly precise geometries, surfaces and the like can be provided for the assembly of the trailing edge element. Furthermore, a replacement of the trailing edge element is thereby facilitated.

According to various embodiments, the trailing edge element is secured to the rotor blade tip via a positive-locking connection. This contributes to the above-mentioned advantages and effects.

According to various embodiments, the trailing edge element is secured to the rotor blade tip via a rail system, a tongue and groove connection or a dovetail connection. This contributes to the above-mentioned advantages and effects, such as, for example, the ease of replacement in the event of wear.

According to various embodiments, the profile trailing edge of the rotor blade extends along a longitudinal axis of the rotor blade starting from a position of maximum profile depth up to the tip-side end in a monotonous manner. Particularly good aeroacoustic properties of the rotor blade are thereby enabled.

According to another aspect, a rotor blade tip for a rotor blade of a wind turbine is described, wherein the rotor blade tip is configured separately from a rotor blade main body of the rotor blade and so as to be able to be connected to the rotor blade main body. The rotor blade tip has a flexibly configured trailing edge element which is adapted with respect to its shaping flush with an outer contour of a suction-side surface and a pressure-side surface of the rotor blade tip and is configured to form a portion of the profile trailing edge of the rotor blade, wherein the path of the portion of the profile trailing edge is monotonous.

The rotor blade tip substantially enables the above-mentioned advantages and functions.

### BRIEF DESCRIPTION OF DRAWINGS

The invention will now be described with reference to the drawings wherein:

FIG. 1 shows a schematic illustration of a wind turbine according to an embodiment;

FIG. 2 shows a schematic illustration of a rotor blade of the wind turbine;

FIG. 3 shows a schematic illustration of a cross sectional profile of a conventional rotor blade tip;

FIG. 4 shows a schematic plan view of a rotor blade at the rotor blade tip according to an embodiment of the disclosure;

FIG. 5 shows a schematic illustration of a cross sectional profile of the rotor blade tip according to FIG. 4; and,

FIGS. 6 and 7 show schematic illustrations of a connection of a trailing edge element to the rotor blade tip according to two embodiments of the disclosure.

### DETAILED DESCRIPTION

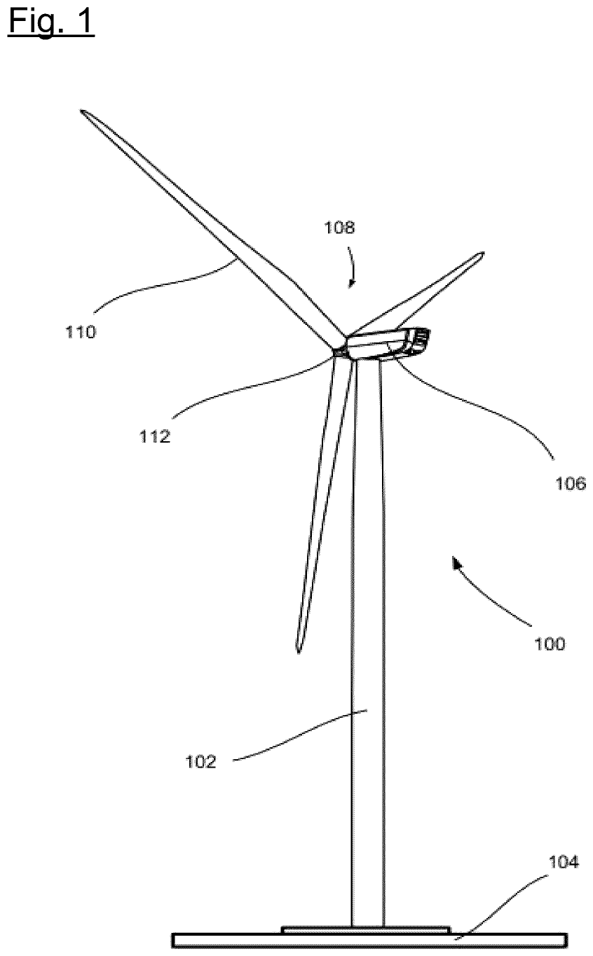

FIG. 1 shows a schematic illustration of a wind turbine 100. The wind turbine 100 has a tower 102. The tower 102 is secured to an underlying base via a foundation 104. At one end of the tower 102 opposite the underlying base, a nacelle 106 is rotatably supported. The nacelle 106 has, for example, a generator which is coupled to a rotor 108 via a rotor shaft (not shown). The rotor 108 has one or more (wind turbine) rotor blades 110 which are arranged on a rotor hub 112.

The rotor 108 is caused to rotate during operation via an air flow, for example, wind. This rotational movement is transmitted via the rotor shaft and where applicable a gear mechanism to the generator. The generator converts the kinetic energy of the rotor 108 into electrical energy.

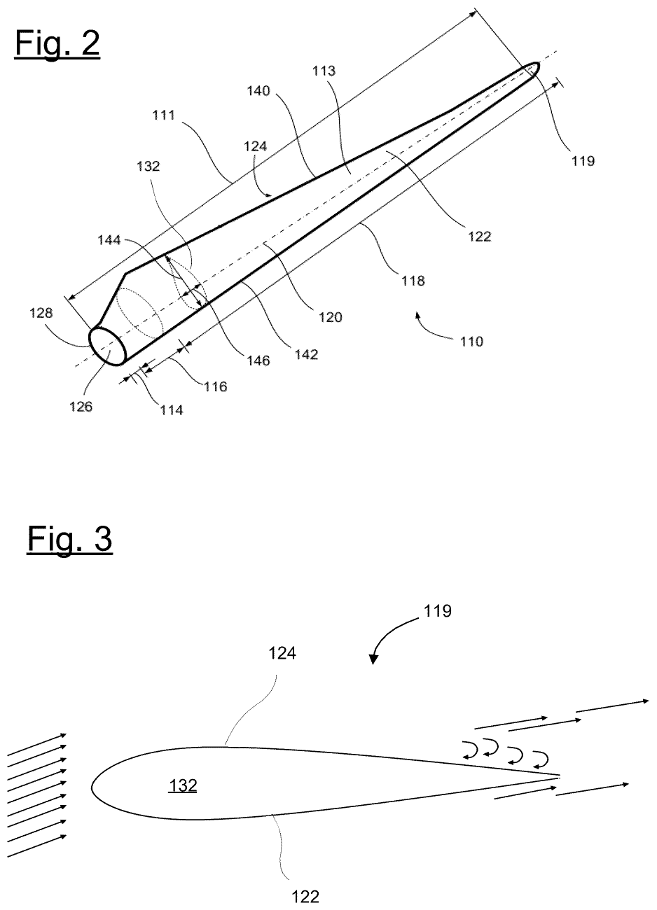

FIG. 2 shows schematically a rotor blade 110. The rotor blade 110 is in the form of a conventional rotor blade and is formed via a rotor blade main body 111 and a rotor blade tip 119. The rotor blade tip 119 is in the form of a separate element. The rotor blade tip 119 is securely connected to the rotor blade main body 111 via an adhesive bond. Of course, the rotor blade tip 119 may be connected differently to the rotor blade main body 111. The rotor blade main body 111 is formed via two half-shells which are made of fiber composite material and which are connected to each other and configured to be substantially hollow internally, wherein it delimits a rotor blade hollow space 113. The rotor blade 110 has a rotor blade root region 114 which faces the rotor hub 112. The rotor blade root region 114 typically has a substantially circular cross section. The rotor blade root region 114 is adjoined by a transition region 116 and a profile region 118 of the rotor blade 110. The rotor blade 110 has with respect to a longitudinal extent direction 120 a pressure side 122 (in this instance, also pressure-side surface) and an opposing suction side 124 (suction-side surface). A rotor blade connection end 126 is provided in the rotor blade root region 114 with a flange connection 128 via which the rotor blade 110 is mechanically connected to a pitch bearing or an extender.

The profile trailing edge 140 and the profile projection edge 142 of the rotor blade 110 are formed by the profile trailing edges and the profile projection edges of both the rotor blade main body 111 and the rotor blade tip 119. A profile depth 144 is defined as a spacing of the profile trailing edge 140 from the profile projection edge 142 with respect to a profile cross section 132. A profile thickness 146 is defined as a spacing of the pressure side 122 from the suction side 124, wherein in the present context the maximum profile thickness of the corresponding profile cross section 132 is intended to be understood. The profile thickness 146 is measured at right-angles with respect to the longitudinal axis 120 and the profile depth 144. A (profile) cross section is located in a plane normal with respect to the longitudinal axis 120.

FIG. 3 shows by way of example, a profile cross section 132 at the rotor blade tip 119 of a conventional rotor blade. Particularly with long rotor blades, in the region of the profile trailing edge 140 undesirable noises may occur as a result of breakaways and turbulence of the air (indicated by the arrows).

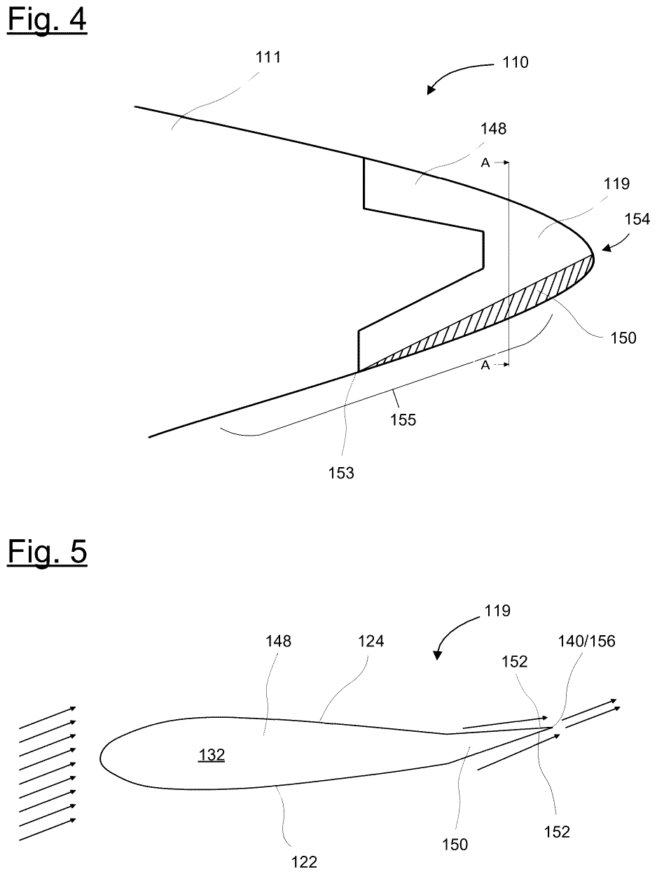

FIGS. 4 and 5 relate to a rotor blade tip 119 according to an embodiment of the disclosure. FIG. 5 shows the section A-A according to the plane of section illustrated in FIG. 4. The rotor blade tip 119 is configured separately from the rotor blade main body 111. The rotor blade tip 119 is formed via a pointed main body 148 and a trailing edge element 150 which are securely mechanically connected to each other. The trailing edge element 150 is configured in a resilient manner and can consequently be flexibly deformed. FIG. 5, which illustrates a profile cross section 132 on the rotor blade tip 119 shows that the downstream edges 152 of the suction-side surface 124 and the pressure-side surface 122 are connected to each other via the profile trailing edge 140. The trailing edge element 150 is adapted with respect to its shaping flush with the outer contour of the suction-side surface 124 and the pressure-side surface 122 of the rotor blade 110 and forms a portion 156 of the profile trailing edge 140 of the rotor blade 110. Between the trailing edge element 150 and the remaining rotor blade 110, along the profile trailing edge 140 a substantially seamless, in particular stepless, transition 153 is formed. In particular, the flush transition 153 is provided between the rotor blade main body 111 and the trailing edge element 150.

As a result of the completely flush fitting of the trailing edge element 150 in the rotor blade 110 or the outer shell thereof, it is possible for the profile trailing edge 140 of the rotor blade 110 to extend in a monotonous manner at the rotor blade tip 119 in the direction of a tip-side end 154 of the rotor blade 110. In other words, a curvature 155 (with respect to the direction of the rotor blade longitudinal axis 120) of the profile trailing edge 140 extends at the rotor blade tip 119 in a monotonous manner. As a result of the flexible configuration of the trailing edge element 150, this can be adapted to air flows, as indicated in FIG. 5. Consequently, the profile trailing edge 140 or the portion 156 is flexible, that is, movable at the rotor blade tip 119. This enables the advantages and functions mentioned in the introduction. An expansion of the profile depth 144 (so-called “chord extension”) is not brought about with the trailing edge element 150.

With regard to the rotor blade 110 illustrated in FIG. 2, there is in a particularly preferred manner provision for the path of the profile trailing edge 140 of the rotor blade 110 to extend over a particularly large longitudinal portion, for example, starting from 50% of the entire length (starting from the direction of the rotor blade root region 114) to the tip-side end 154 in a monotonous manner.

The tip main body 148 is formed from a metal material, for instance aluminum or an aluminum material. The trailing edge element 150 is, for example, formed from a plastics material, such as polyurethane, and has a modulus of elasticity in the range from 0.01 to 1.5. In particular, the trailing edge element 150 is more flexible than the remaining rotor blade 110 and in particular in the form of the tip main body 148.

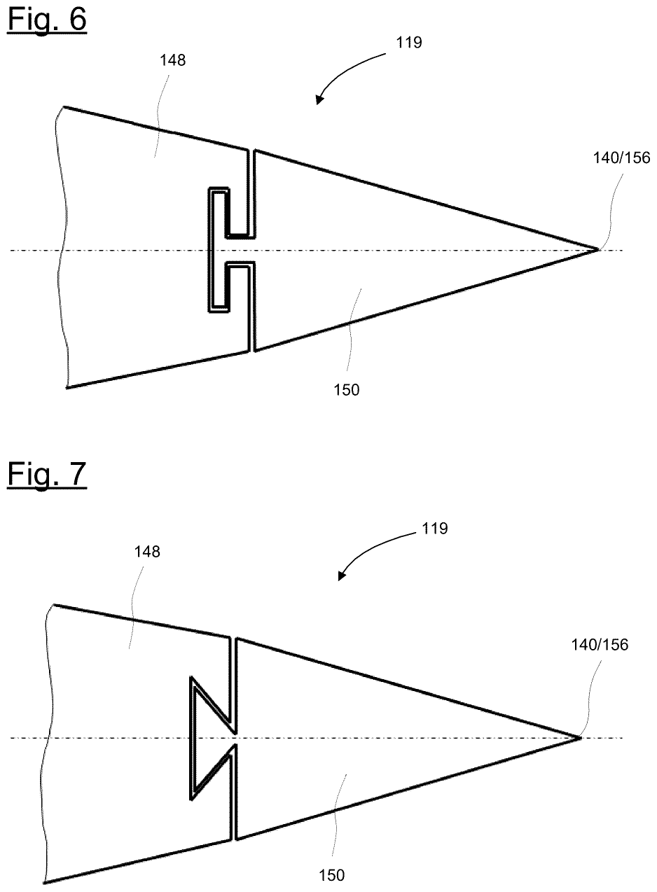

The trailing edge element 150 may be connected in a different manner to the rotor blade tip 119, that is, the tip main body 148. Preferably, the trailing edge element 150 is connected to the tip main body 148 in a positive-locking manner. To this end, the production from metal is advantageous for the tip main body 148 since particularly precise geometries and consequently secure and stable connections can thereby be produced. Reference is made by way of example to FIGS. 6 and 7 which show a rail-like connection 158 (or: rail mechanism) or a dovetail connection 160. Other connection types, such as an adhesive connection or a screw, bolt and/or rivet connection are also conceivable.

It is understood that the foregoing description is that of the preferred embodiments of the invention and that various changes and modifications may be made thereto without departing from the spirit and scope of the invention as defined in the appended claims.

List of reference numerals

| | |
|---|---|
| 100 | Wind turbine |
| 102 | Tower |
| 104 | Foundation |
| 106 | Nacelle |
| 108 | Rotor |
| 110 | Rotor blade |
| 111 | Rotor blade main body |
| 112 | Rotor hub |
| 113 | Rotor blade hollow space |
| 114 | Rotor blade root region |
| 116 | Transition region |
| 118 | Profile region |
| 119 | Rotor blade tip |
| 120 | Longitudinal extent direction |
| 122 | Pressure side |
| 124 | Suction side |
| 126 | Rotor blade connection end |
| 128 | Flange connection |
| 132 | Profile cross section |
| 140 | Profile trailing edge |
| 142 | Profile projection edge |
| 144 | Profile depth |
| 146 | Profile thickness |
| 148 | Tip main body |
| 150 | Trailing edge element |
| 152 | Downstream edge |
| 153 | Transition |
| 154 | Tip-side end |
| 155 | Curvature |
| 156 | Portion of the profile trailing edge |
| 158 | Rail-like connection |
| 160 | Dovetail connection |
| A-A | Section |

1-11. (canceled)

12. A rotor blade for a wind turbine, the rotor blade comprising:
a rotor blade main body and a rotor blade tip adjoining the rotor blade main body;
a suction-side surface defining an outer contour;
a pressure-side surface defining an outer contour;
a profile trailing edge;
said suction-side surface and said pressure-side surface having respective downstream edges connected to each other at said profile trailing edge;
said rotor blade tip having a flexibly configured trailing edge element defining a shape adapted to be flush with the respective outer contours of said suction-side surface and said pressure-side surface; and,
said trailing edge element forming a portion of said profile trailing edge so as to cause said profile trailing edge at said rotor blade tip to extend in a direction of a tip-side end of said rotor blade in a monotonous manner.

13. The rotor blade of claim 12, wherein said trailing edge element and a remaining rotor blade conjointly form a seamless transition therebetween along said profile trailing edge.

14. The rotor blade of claim 13, wherein said seamless transition is a stepless transition.

15. The rotor blade of claim 12, wherein said trailing edge element is free from a profile depth expansion at said profile trailing edge.

16. The rotor blade of claim 12, wherein said portion of said profile trailing edge is formed by said trailing edge element and said portion has a curvature changing in a monotonous manner.

17. The rotor blade of claim 12, wherein said trailing edge element is formed from an elastomer material.

18. The rotor blade of claim 12, wherein said rotor blade tip is configured separately from said rotor blade main body and is connected to said rotor blade main body.

19. The rotor blade of claim 12, wherein said rotor blade tip is formed from an electrically conductive material.

20. The rotor blade of claim 12, wherein said trailing edge element is secured to said rotor blade tip by a positive-locking connection.

21. The rotor blade of claim 20, wherein said trailing edge element is secured to said rotor blade tip by one of the following: i) a rail system, ii) a tongue and groove connection or iii) a dovetail connection.

22. The rotor blade of claim 12, wherein said profile trailing edge of said rotor blade extends along a longitudinal axis of said rotor blade starting from a position of maximum profile depth up to said tip-side end in a monotonous manner.

23. A rotor blade tip for a rotor blade of a wind turbine, the rotor blade having a rotor blade main body and the rotor blade tip comprising:
Said rotor blade tip being configured separately from a rotor blade main body so as to be connectable to said rotor blade main body; and,
a flexibly configured trailing edge element adapted with respect to shape thereof flush with an outer contour of a suction-side surface and an outer contour of a pressure-side surface of said rotor blade tip and said trailing edge element being configured to form a portion of the profile trailing edge of the rotor blade wherein a path of the portion of said profile trailing edge is monotonous.
